(19) United States
(12) Patent Application Publication
(10) Pub. No.: US 2008/0186188 A1
(43) Pub. Date: Aug. 7, 2008

(54) LABEL PAPER WITH RFID FUNCTION AND RFID TAG WRITING APPARATUS

(76) Inventor: Wei Chang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/941,058

(22) Filed: Nov. 15, 2007

(30) Foreign Application Priority Data
Feb. 7, 2007 (TW) 096104454

(51) Int. Cl. G06K 1/00; B42D 15/00

(52) U.S. Cl. 340/572.8; 283/83; 347/9

(57) ABSTRACT

Disclosed is a label paper with RFID function, which includes a label and an RFID tag chip. The RFID tag chip, which is located on the label and comprises an embedded antenna, is used for receiving, storing and transmitting identification data. An RFID tag writing apparatus for accessing the label paper with RFID function is also disclosed.

### BACKGROUND OF THE INVENTION

1. Field of the Invention

The present invention relates to label paper with RFID function and an RFID tag writing apparatus, and particularly relates to label paper with RFID function having an RFID tag chip with an embedded antenna, and to a printer, which is able to write identification data to the RFID label.

2. Description of the Prior Art

In recent years, RFID (RF identification) technology has become increasingly popular. As well as its utilization in various kinds of travel cards and credit cards, RFID is also used for identifying articles such as books or medicine.

FIG. 1 illustrates a prior art label paper 100 with RFID function. As shown in FIG. 1, the RFID tag chip 101 is usually combined with an antenna substrate 103, which is generally made by plastic, to form an inlet tag. The inlet tag is then adhered to the label paper having binder smeared thereon, such that a roll of label paper with RFID function is formed.

This label paper will be shipped to a trading company or a factory, and an RFID label printer is utilized to write data to the RFID tag chip 101. FIG. 2 illustrates a prior art RFID label printer, which is disclosed in US patent publication No. 2006/0138229. As shown in FIG. 2, the label paper 203 with RFID function is fed into the RFID label printer 200 along direction A, and then the RFID label printer 200 utilizes a fixed RFID accessing device 201 to write data to the label paper 203 with RFID function. Further detailed operation of the RFID label printer 200 and related information is disclosed in US patent publication No. 2006/0138229, and is thus omitted here for brevity.

The RFID label printer 200 is specially designed for a factory and is therefore usually large in size and has high price. Additionally, for mass production there are usually at least 500 units (and probably even 1000 units) in one roll of typical label paper with RFID function. Furthermore, conventional label paper with RFID function usually has a large antenna for long distance reading, such that the conventional label paper with RFID function will be large in size, and the manufacturing method also results in high cost. As conventional label paper with RFID function has the disadvantages of high cost and large size, it is only suitable for industrial purposes, but not for individuals and small businesses.

### SUMMARY OF THE INVENTION

Therefore, one objective of the present invention is to provide a label paper with RFID function, which has low cost and small size.

Another objective of the present invention is to provide an ink cartridge which is capable of writing data to label paper with RFID function and can be applied to a normal printer.

Still another objective of the present invention is to provide a printer capable of writing RFID label.

One embodiment of the present invention discloses a label paper with RFID function, which comprises: a label paper and an RFID tag chip. The RFID tag chip is located on the label paper and has an embedded antenna. The RFID tag chip is for receiving, storing and transmitting identification data.

Another embodiment of the present invention discloses an RFID tag writing apparatus, which is used for writing an identification data to a label paper with RFID function. The apparatus comprises: a moving mechanism, and an RFID tag writing device, which is provided on the moving mechanism. The moving mechanism moves the RFID tag writing device to write to a label paper with RFID function.

Another embodiment of the present invention discloses an ink cartridge for a printer. The ink cartridge comprises: a signal receiving region, for receiving a first control signal and a second control signal from the printer, and an RFID tag writing device, coupled to the signal receiving region to receive the second control signal. The ink cartridge operates according to the first control signal, and the RFID tag writing device operates according to the second control signal.

Another embodiment of the present invention discloses an ink cartridge for a printer. The ink cartridge comprises: a first signal receiving region, for receiving a first control signal; a second signal receiving region, for receiving a second control signal from the printer; and an RFID tag writing device, coupled to the second signal receiving region for receiving the second control signal. The ink cartridge operates according to the first control signal, and the RFID tag writing device operates according to the second control signal.

According to the above-mentioned embodiments, not only the size and cost of the label paper with RFID function can be decreased, but also a normal printer can be utilized to write data to the label paper with RFID function, thereby the application scope of the RFID label can be increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a prior art label paper with RFID function.

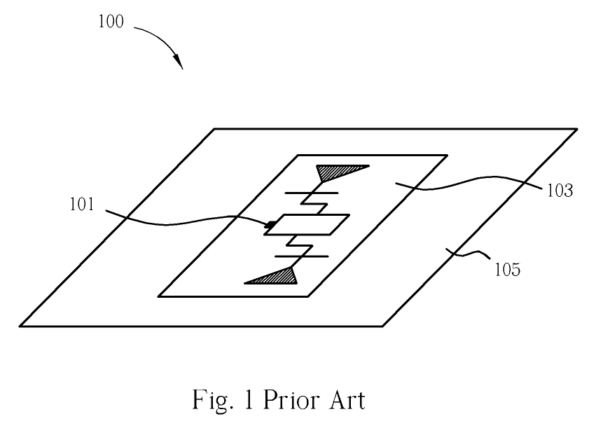

FIG. 2 illustrates a prior art RFID label printer.

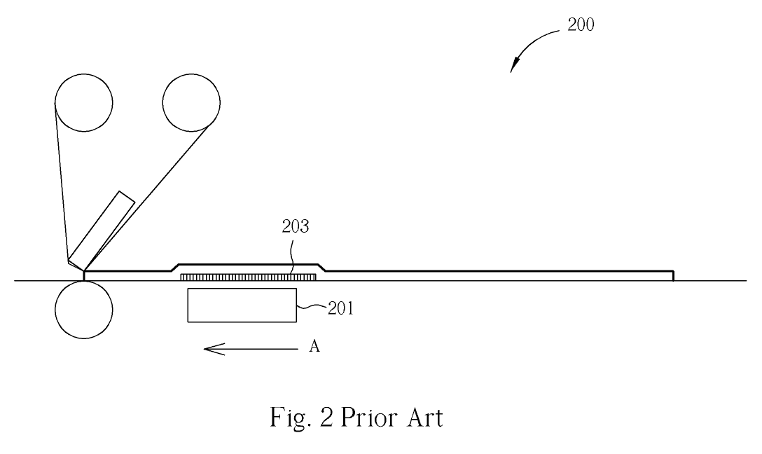

FIG. 3 illustrates a label paper with RFID function according to an embodiment of the present invention.

FIG. 4 illustrates an RFID tag chip with an embedded antenna.

FIG. 5 illustrates a printer capable of writing RFID label according to an embodiment of the present invention.

FIG. 6 illustrates an ink cartridge according to a first embodiment of the present invention.

FIG. 7 is a side view of the ink cartridge shown in FIG. 6.

FIG. 8 illustrates an ink cartridge according to a second embodiment of the present invention.

### DETAILED DESCRIPTION

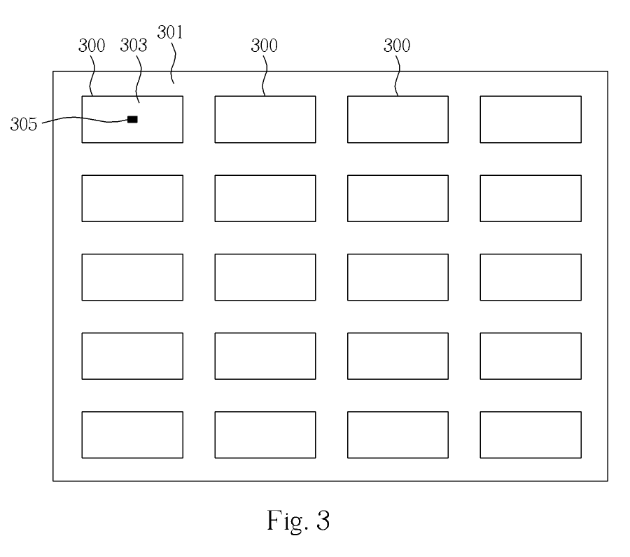

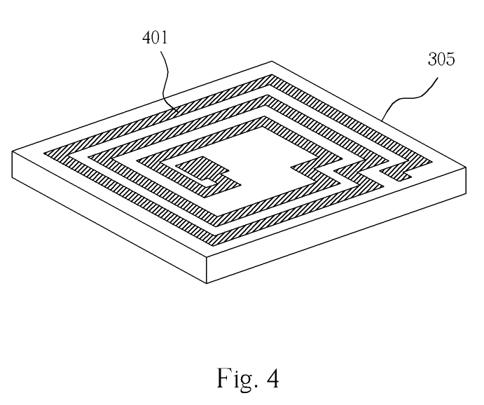

FIG. 3 illustrates a label paper with RFID function according to an exemplary embodiment of the present invention. As shown in FIG. 3, a plurality of label papers with RFID function 300 is located on a release paper 301, and each label paper with RFID function 300 includes a label paper 303 and an RFID tag chip 305. In this embodiment, the RFID tag chip 305 is located between the label paper 303 and the release paper 301, but this is not meant to limit the scope of the present invention. The RFID tag chip 305 includes an embedded antenna 401 for receiving or transmitting identification data, as shown in FIG. 4. It should be noted that the RFID tag chip with an embedded antenna is well known by persons skilled in the art and can be various kinds of types; therefore the RFID tag chip 305 shown in FIG. 4 is only given as an example and is not meant to limit the scope of the present invention.

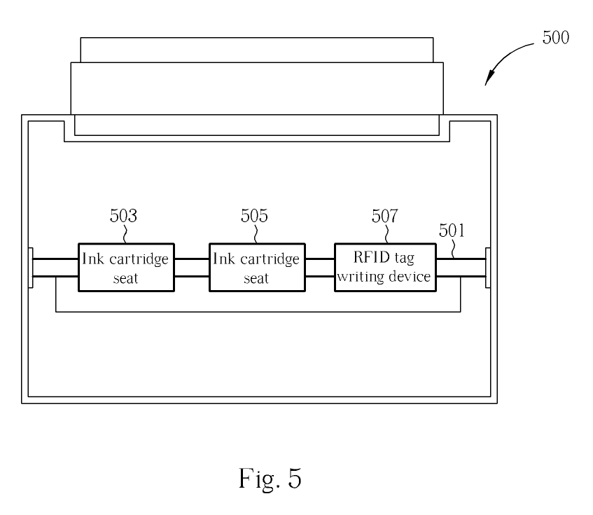

FIG. 5 illustrates a printer 500 capable of writing RFID tag according to an embodiment of the present invention. The printer 500 can be a normal printer utilized by a company or a family. As shown in FIG. 5, the printer 500 includes a moving mechanism 501 for moving ink cartridge seats 503 and 505. The ink cartridge seats 503 and 505 are usually used for housing a color ink cartridge or a black ink cartridge. Besides the ink cartridge seats 503 and 505, the RFID tag writing device 507 can also be directly mounted on the moving mechanism 501, and the RFID tag writing device 507 is moved to write identification data to the label paper with RFID function via the moving mechanism 501. In this embodiment, an RFID tag writing device seat is provided on the moving mechanism 501 (not illustrated), and the RFID tag writing device 507 is installed on the RFID tag writing device seat, but this is not meant to limit the scope of the present invention. It should be noted that the embodiment shown in FIG. 5 is not limited to be applied to a printer, and can be applied to other apparatus with a moving mechanism.

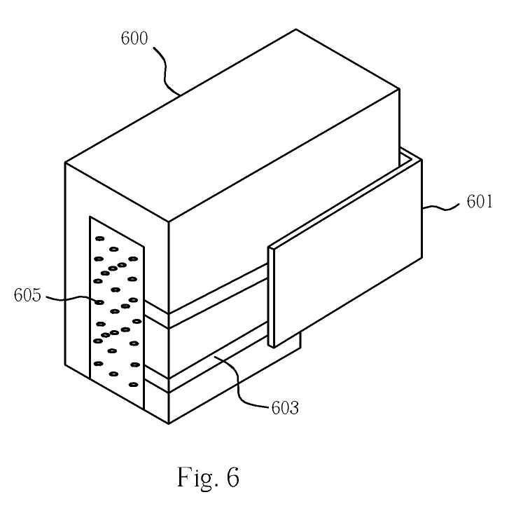

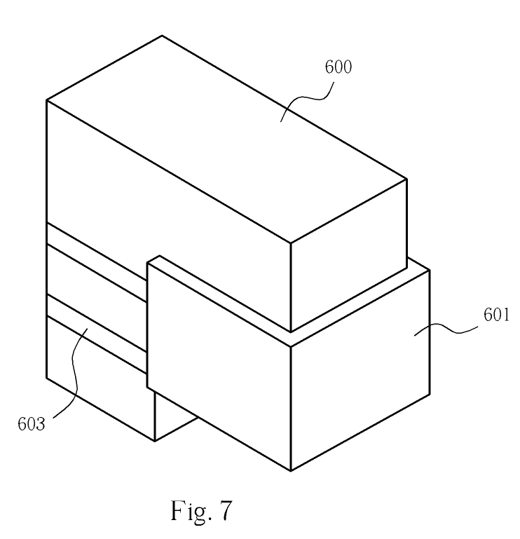

FIG. 6 illustrates an ink cartridge 600 according to a first embodiment of the present invention, and FIG. 7 is a side view of the ink cartridge shown in FIG. 6. As shown in FIG. 6, a RFID tag writing device 601 is located on the ink cartridge 600 and is coupled to a signal receiving region 605 via a conduction line 603. The signal receiving region 605 is utilized for receiving a control signal for controlling the ink cartridge 600 and a controlling signal for controlling the RFID tag writing device 601. In this embodiment, the RFID tag writing device 601 is an independent unit that can be combined with the ink cartridge 600, but this is not meant to limit the scope of the present invention. The RFID tag writing device 601 can be removably mounted on the ink cartridge 600, thus the RFID tag writing device 601 can be disassembled from the ink cartridge 600 and be mounted on a new ink cartridge when the ink cartridge 600 is empty. The RFID tag writing device 601 can also be provided to the ink cartridge 600 by an irremovable method, which also falls within the scope of the present invention.

In this embodiment, the control signals for the ink cartridge 600 and the RFID tag writing device 601 are from the same signal receiving region. However, more than one signal receiving region can be provided to the ink cartridge 600 to respectively receive the control signals of the ink cartridge 600 and the RFID tag writing device 601; this also falls in the scope of the present invention. FIG. 7 is a side view of the ink cartridge shown in FIG. 6; thereby the relative position between each device can be understood from a different angle.

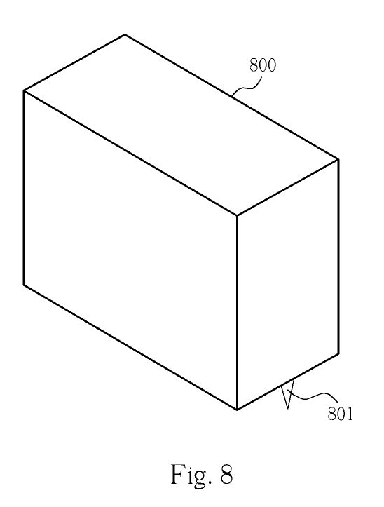

FIG. 8 illustrates an ink cartridge 800 according to a second embodiment of the present invention. In this embodiment, the RFID tag writing device is provided inside the ink cartridge 800 to form an ink cartridge with an embedded RFID tag writing device. Such kind of ink cartridge only utilizes an accessing head 801 protruding from the ink cartridge 800 to write identification data to the label paper with RFID function. Additionally, since such kind of ink cartridge has an RFID tag writing device integrated with the ink cartridge, the ink cartridge and the RFID tag writing device should be jointly renewed. Similarly, such kind of RFID tag writing device can share the same signal receiving region with the ink cartridge to receive control signals, or utilize different signal receiving regions to receive respective control signals. It should be noted that the ink cartridge 800 is only given as an example and not as a limitation of the present invention. The location and the shape of the accessing head 801 can be changed, which also falls within the scope of the present invention.

According to the above-mentioned embodiments, not only the size and cost of the label paper with RFID function can be decreased, but also a normal printer can be utilized to write data to a label paper with RFID function, thereby increasing the application scope of the RFID label.

Those skilled in the art will readily observe that numerous modifications and alterations of the device and method may be made while retaining the teachings of the invention.

What is claimed is:

1. A label paper with RFID function, comprising:
a label paper; and
an RFID tag chip, located on the label paper and having an embedded antenna, for receiving, storing and transmitting identification data.

2. An RFID tag writing apparatus, for writing identification data to a label paper with RFID function, comprising:
a moving mechanism; and
an RFID tag writing device, provided on the moving mechanism, wherein the moving mechanism moves the RFID tag writing device to write identification data to the label paper with RFID function.

3. The RFID tag writing apparatus of claim 2, wherein the label paper with RFID function comprises an RFID tag chip for receiving, storing and transmitting the identification data, where the RFID tag chip includes an embedded antenna.

4. The RFID tag writing apparatus of claim 2, being a printer, wherein the printer further comprises an ink cartridge seat located on the moving mechanism.

5. The RFID tag writing apparatus of claim 2, being a printer, wherein the RFID tag writing device is integrated with an ink cartridge in the printer.

6. The RFID tag writing apparatus of claim 5, wherein the printer utilizes a first control signal to control the operation of the ink cartridge and the printer utilizes a second control signal to control the operation of the RFID tag writing device, where the ink cartridge includes a signal receiving region for receiving the first control signal and the second control signal, and the RFID tag writing device is coupled to the signal receiving region for receiving the second control signal.

7. The RFID tag writing apparatus of claim 5, wherein the printer utilizes a first control signal to control the operation of the ink cartridge and the printer utilizes a second control signal to control the operation of the RFID tag writing device, where the ink cartridge includes a first signal receiving region for receiving the first control signal and a second signal receiving region for receiving the second control signal, and the RFID tag writing device is coupled to the second signal receiving region for receiving the second control signal.

8. The RFID tag writing apparatus of claim 5, wherein the RFID tag writing device is provided inside the ink cartridge to form an ink cartridge with an embedded RFID tag writing device.

9. The RFID tag writing apparatus of claim 5, wherein the RFID tag writing device is an independent unit that can be combined with the ink cartridge.

10. An ink cartridge for a printer, comprising:
a signal receiving region, for receiving a first control signal and a second control signal from the printer, and operating according to the first control signal; and
an RFID tag writing device, coupled to the signal receiving region for receiving the second control signal, and operating according to the second control signal.

11. The ink cartridge of claim 10, wherein the RFID tag writing device is provided inside the ink cartridge to form an ink cartridge with an embedded RFID tag writing device.

12. The ink cartridge of claim 10, wherein the RFID tag writing device is an independent unit that can be combined with the ink cartridge.

13. An ink cartridge for a printer, comprising:
a first signal receiving region, for receiving a first control signal from the printer, wherein the ink cartridge operates according to the first control signal;
a second signal receiving region, for receiving a second control signal from the printer; and
an RFID tag writing device, coupled to the second signal receiving region to receive the second control signal, and operating according to the second control signal.

14. The ink cartridge of claim 13, wherein the RFID tag writing device is provided inside the ink cartridge to form an ink cartridge with an embedded RFID tag writing device.

15. The ink cartridge of claim 13, wherein the RFID tag writing device is an independent unit that can be combined with the ink cartridge.
